(19) United States
(12) Patent Application Publication
(10) Pub. No.: US 2025/0167530 A1
(43) Pub. Date: May 22, 2025

(54) Installation for preparing a section of electric cable

(71) Applicant: NEXANS, Courbevoie (FR)

(72) Inventors: François SESSOUC, CALAIS (FR); Nicolas LALLOUET, BAINCTHUN (FR)

(21) Appl. No.: 18/927,835

(22) Filed: Oct. 25, 2024

(30) Foreign Application Priority Data
Oct. 27, 2023 (FR) 2311742

(51) Int. Cl. H02G 1/12

(52) U.S. Cl. CPC H02G 1/1248

(57) ABSTRACT

An installation (101) for preparing a cable (1) includes a conductor surrounded by an insulation system (2) having at least one insulating layer (3) and at least one outer semiconducting layer (5). The installation has a cooling device (101) for cooling a section of the cable (1) in the form of a cylindrical cooling box (102) containing dry ice. The electric cable (1) passes through the box (102) in order to be cooled below the glass transition temperature of the outer semiconducting layer (5) and then allow the outer semiconducting layer (5) to be machined.

### RELATED APPLICATION

This application claims the benefit of priority from French Patent Application No. 22 11742, filed on Oct. 27, 2023, the entirety of which is incorporated by reference.

### FIELD OF THE INVENTION

The present invention relates to an installation for preparing a section of electric cable, this section having a length of between 1 m and 1.5 m, for example.

Hereinafter in the description, the terms “cable” and “electric cable” are equivalent.

### DESCRIPTION OF RELATED ART

Generally, an electric cable comprises an electrical conductor surrounded by an insulation system that may comprise at least one layer of electrical insulation and one layer of semiconductor. Such an electric cable is generally plugged into an electrical connector in order to supply electricity to a building, a room or a piece of equipment, or to transmit electricity to part of the network. In order to provide this connection, at least part of the insulation system of said cable needs to be removed, in particular on the section thereof that is intended to interact directly with the electrical connector. In order to perform this removal of material, a cutting device involving a cutting blade is used, said blade cutting the part of the insulation system that is to be removed.

However, some of the materials making up the insulating layer and the semiconducting layer are too soft and/or too elastic to be cut cleanly in this way. Indeed, during this cutting operation, these materials will first be deformed on contact with the cutting blade. Then, when they are cut, they will have an end edge resulting from this cut which will not be smooth and, therefore, well defined. This may have harmful repercussions on the properties of said cable.

### OBJECTS AND SUMMARY

An installation according to the invention is designed to place the insulation system of the cable in optimized conditions in order to be able to carry out operations structurally modifying said cable that are under perfect control.

The invention relates to an installation for preparing a cable comprising a conductor surrounded by an insulation system comprising at least one insulating layer and at least one semiconducting layer.

According to the invention, the installation has a device for cooling a section of said cable in the form of a cylindrical cooling box delimited by a cylindrical side wall and by two circular end faces, each provided with a circular opening, the cylindrical side wall having at least one supply port through which a coolant material is introduced into the box, the electric cable passing through the box via the circular openings in the two end faces and being in contact with the coolant material placed in the cylindrical box. The cylindrical box may have a circular or rectangular cross-section. In order to remove any ambiguity, the electric cable and the coolant material are part of the installation and are not external to it. An installation according to the invention can therefore be used to cool the cable provided with its peripheral insulation system in order to harden the layer of semiconductor and the layer of insulation of the cable. This makes it possible, for example, to carry out cutting operations on said at least two layers, in order to prepare the cable in optimized conditions, in particular with a cut that has a smooth, controlled appearance, so that it can be plugged into an external electrical connector. The cylindrical cooling box is designed to surround a section of the electric cable so that said section cools in contact with the coolant material. If a cutting operation needs to be performed on the insulation system of the cable, it will be carried out on said cooled section. The coolant material may be in liquid, solid or gel form. The cooling of the cable in the cooling box may take place either directly, by contact with the coolant material, or indirectly, by means of a cylindrical wall surrounding the cable and having thermal conduction properties. One side of this conductive wall would be in contact with the coolant material, with the other side in contact with the cable. The electric cable preferably passes through the two circular openings of the two end faces without creating any clearance with the edge of said end walls delimiting said openings. As a result, the inner space delimited by the cylindrical cooling box and in which the coolant material is placed will be thermally well insulated. Preferably, once the coolant material has been introduced into the cylindrical cooling box, a stopper can be introduced into the supply port of said box in order to better thermally insulate the inner space delimited by said cooling box. Advantageously, the cylindrical box is positioned in the installation in such a way that its axis of revolution extends horizontally. For this configuration, the coolant material present in said box extends over a height greater than a radius of said box, and in particular so as to cover the cable at least partially, and better still entirely, around its circumference, the cable being kept at a distance from the bottom of the box.

According to one possible feature of the invention, the cylindrical box is made from a thermally insulating material or set of materials, so that the coolant material only cools the cable and the coolant does not warm up quickly, losing its effectiveness. This insulation helps increase the efficiency of the installation so that several sections of electric cable can be prepared in succession. Another advantage of thermally insulating the installation is that it protects operators from cold burns. The material of the cooling box may be made from PVC, for example, and this layer of PVC may itself preferably be thermally insulated with a layer of expanded polyurethane foam surrounding the layer of PVC. Alternatively, the box may be formed from polystyrene and have a rectangular cross section, and be provided with a single removable cover. The coolant material preferably reduces the temperature of the cable by thermal conduction.

According to one possible feature of the invention, the cylindrical box has at least two and, for example, three supply ports through which the coolant material is introduced. Said three supply ports are positioned along a top region of the cylindrical box, being aligned along a longitudinal axis of this box. For this configuration, it is assumed that the cylindrical cooling box is oriented in space in such a way that its axis of revolution extends horizontally. The three supply ports are evenly spaced apart along the cylindrical box so that the coolant material can evenly occupy the inner space delimited by the cooling box, thus ensuring balanced cooling of the cable along its longitudinal axis. The distance between the ports is designed to ensure that the coolant material is distributed along the length of box, along the cable. Once the coolant material has been introduced into the cylindrical cooling box, the three supply ports can be closed by stoppers in order to thermally insulate the inner space delimited by this cooling box.

According to one possible feature of the invention, the two end faces are flat and parallel to each other.

According to one possible feature of the invention, the circular openings of the two end faces, which are used to insert the cable into the box and position it, each occupy a central position on the corresponding end face. As a result, the cylindrical side wall of the cooling box and the insulation system of the cable are coaxial, providing a space of constant width between them which is at least partially filled by the coolant material, the presence of this constant space ensuring even cooling of the section of cable inserted into the cooling box.

According to one possible feature of the invention, the coolant material consists of a plurality of pieces of dry ice. The pieces of ice are easy to produce and are therefore inexpensive. They also allow the temperature of the insulation system of the cable to be effectively lowered. These pieces of ice are placed loose, i.e., in no particular arrangement, in the cooling box. The dry ice or carbon dioxide snow is, for example, at a temperature of between −60° C. and −80° C. and, in particular, in the region of −78° C. The advantage of dry ice is that it does not leave any aqueous residue, as it evaporates at room temperature.

According to one possible feature of the invention, the pieces of ice are all of substantially the same size when they are introduced. In particular, the pieces are all in the form of cylindrical sticks having a circular cross section with a diameter of between 1 and 25 mm and a length of between 0.5 and 10 cm. In this way, with standard pieces of ice, the pieces of ice will be evenly distributed in the cooling box, helping to ensure even cooling of the cable in said cooling box. If the pieces of ice had very different profiles, hollow regions with no pieces of ice would be created in the cooling box and would alter the cooling conditions of the cable in the cooling box.

The size of the pieces is optimized to prevent these pieces from falling out through a space between the cable and the circular openings provided in the side faces of the box, and to facilitate their fluid distribution in the box when they are introduced.

According to one possible feature of the invention, the insulation system of the cable includes a layer of insulation surrounded by an inner layer of semiconductor and by an outer layer of semiconductor. The layer of insulation is therefore inserted between the inner layer and the outer layer of semiconductor.

According to one possible feature of the invention, the installation comprises a device for cutting the outer layer of semiconductor and the layer of insulation in order to prepare a section of the electric cable, the cutting device comprising a cutting blade and being used after said outer layer of semiconductor and said layer of insulation have been brought to a temperature lower than their glass transition temperature. The cutting operation takes place after the outer layer of semiconductor and the layer of insulation have been brought to a temperature that is lower than their glass transition temperature. These layers will therefore have been hardened before the cutting operation begins.

According to one possible feature of the invention, the installation comprises a common unit inside which the cooling device and the cutting device are fixed, said common unit being mounted in such a way as to be able to move along the electric cable. For this configuration, the cooling device and the cutting device are combined in a common unit, which is mounted in such a way as to be able to move along the cable. The possibility of moving this common unit along the cable makes an installation according to the invention more flexible to use because it allows a more or less long section of the cable, or several separate sections of said cable, to be processed, and makes the cooling operation and the cutting operation inseparable from each other.

The invention also relates to a method for preparing an electric cable by using an installation according to the invention.

According to the invention, the method comprises the following steps:
a step of fixing the cooling box around the section of electric cable to be cooled,
a step of filling the cooling box with the coolant material, via the supply ports,
a step of cooling said section of the electric cable by means of the cylindrical cooling box,
a step of cutting the outer layer of semiconductor of the cable by means of the cutting blade, after said outer layer of semiconductor and said layer of insulation have been brought to a temperature lower than their glass transition temperature by virtue of the cooling device.

The aim of the method according to the invention is to remove the entire outer layer of semiconductor, removing as little as possible of the layer of insulation adjacent to and to the inside of this outer layer of semiconductor. The aim of the invention is to remove only part of the insulating layer, in a proportion of between 0 and 15% of its radial thickness, for example, in the region of 0.5 mm, for example. For this reason, the duration of cooling of the cable needs to allow the cable to be cooled thoroughly so that the thermal gradient observed in the cable allows the entire outer layer of semiconductor and the layer of insulation to be at a temperature lower than their respective glass transition temperatures before machining.

This method may be supplemented by a step of closing the supply ports with stoppers once the coolant material has been introduced into the cooling box. According to one possible feature of the invention, the method comprises a step

of moving a common unit along the electric cable in order to gradually prepare a section of said electric cable.

An installation according to the invention has the advantage of having a carefully designed cooling device, the geometry of which is suited to that of a cable to be cooled in order to ensure even cooling of a section thereof, and the dimensions of which are compact so as not to take up space in said installation. This cooling device also has the advantage of using a coolant material that is inexpensive and that is perfectly effective in bringing about efficient cooling of the cable.

### BRIEF DESCRIPTION OF THE DRAWINGS

A detailed description is provided below of a preferred embodiment of an

installation for preparing a cable according to the invention, in reference to the following figures:

FIG. 1 is a side view of an installation according to the invention, showing a cable and a cooling device,

FIG. 2 is a front view of several pieces of ice constituting the coolant material of a cooling device of an installation according to the invention,

FIG. 3 is the side view of FIG. 1 showing the coolant material in the cooling device by virtue of transparency,

FIG. 4 is a perspective view of a section of cable and a cutting device of an installation according to the invention,

FIG. 5 is one face of a cable that has been prepared by means of an installation according to the invention,

FIG. 6 is a cross-sectional view of the cable in the box under a depth of coolant according to the invention.

### DETAILED DESCRIPTION

Some electric cables 1 having a conductor surrounded by an electrical insulation system 2 need to be prepared before they can be inserted into external electrical connectors in order to supply power to a structure that may, for example, be a building, a vehicle or an electrical apparatus. Schematically, this preparation consists in cutting part of the insulation system 2 of the cable 1 in order to expose said cable 1 over a section of predefined length. As some layers of the insulation system 2 of the cable 1 are made from soft materials having a certain elasticity, cleanly cutting these layers may prove to be a complicated operation. Indeed, during this cutting operation, the layers in question of the insulation system 2 will first be deformed, before they are cut. As a result, the end edge 15 of at least one of these layers, and the surface of the insulator 3 obtained following this cut, will be neither regular nor smooth, which risks compromising the properties of the electric cable 1.

It has been observed that cooling the layers of the insulation system 2 of the cable 1 in advance hardens these layers and therefore makes it easier to cut them when preparing a section of the cable 1.

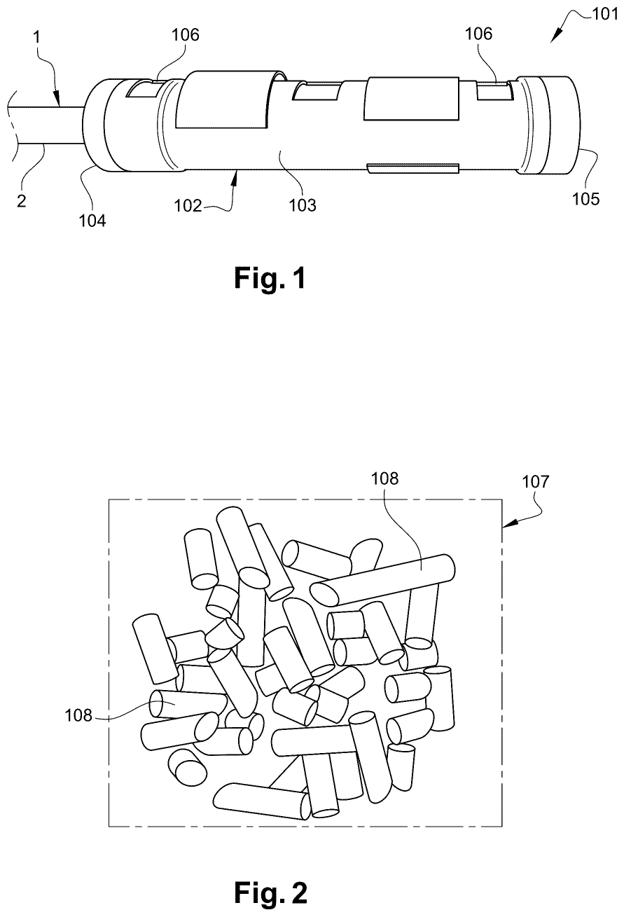

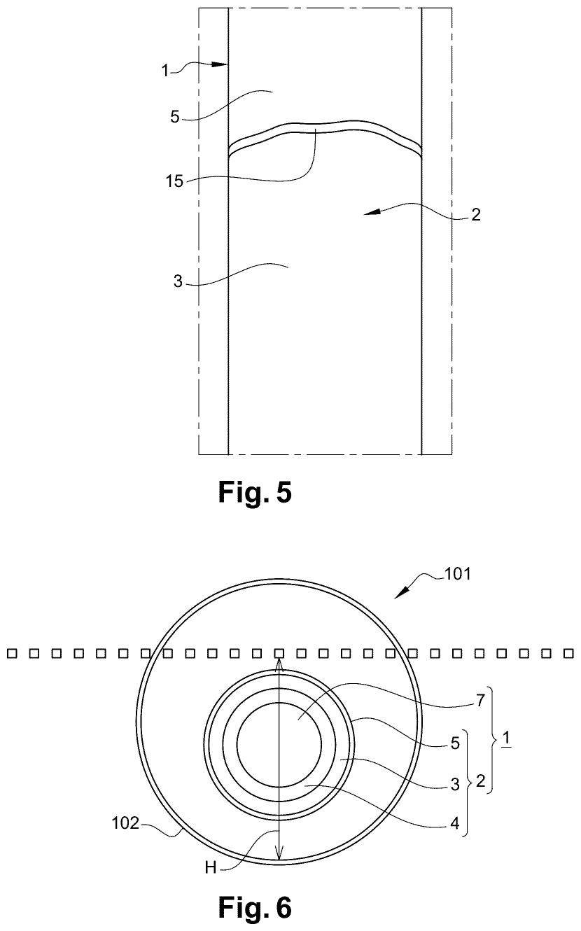

In reference to FIGS. 1, 3, 4 and 5, an installation 101 according to the invention comprises a cable 1 and a cooling device 101 for cooling said cable 1. The cable 1 comprises a conductor 7 surrounded by an insulation system 2 comprising a layer of insulation 3, an inner layer of semiconductor and an outer layer 5 of semiconductor, said layer of insulation 3 being positioned between said inner layer 4 and said outer layer 5. The cable 1 comprising the conductor 7 and the insulation system 2 has a circular cross section.

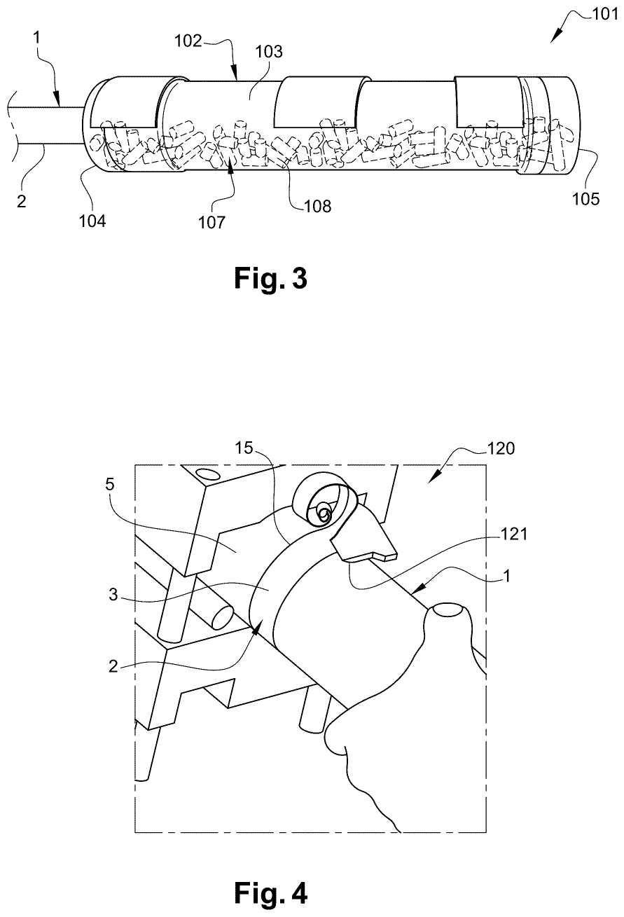

The cooling device 101 comprises a cylindrical cooling box 102 made from PVC. This cooling box 102 is delimited by a cylindrical side wall 103 and by two circular end faces 104, 105 each having a central opening. These two end faces 104, 105 are parallel to each other and each extend in a plane that is perpendicular to an axis of revolution of the cylindrical side wall 103. The central openings of the two end walls 104, 105 are circular and of the same diameter, which is greater than or equal to the external diameter of the cable 1. The cylindrical cooling box 102 is positioned around the cable 1 in such a way that said cable 1 passes through the central openings of the two end walls 104, 105. The cylindrical side wall 103 of the cooling box 102 comprises supply ports 106 through which a coolant material 107 is introduced into said cooling box 102. These supply ports 106 are evenly spaced apart along the cooling box 102, so that the coolant material 107 is spread evenly along said cooling box 102. In reference to FIGS. 2 and 3, this coolant material 107 is constituted by a plurality of pieces 108 of dry ice. Advantageously, these pieces 108 of ice are preferably in the form of sticks of approximately the same geometry and dimensions. As a result, because they are all virtually identical, the sticks of ice 108 will mix closely in the cylindrical cooling box 102 without leaving any regions without sticks 108 of ice. The cable 1 extends horizontally in the installation 101 such that the axis of revolution of the cooling box 102, which is positioned around said cable 1, also extends horizontally. These sticks of ice 108 are poured into the cooling box 102 through the supply ports 106 until they reach a height H that is greater than half the height of the cooling box 102. The coolant is added until it covers the cable. In this way, the cable 1 and, more precisely, the outer layer 5 of semiconductor of the insulation system 2, is in direct contact with the sticks 108 of ice placed in the cooling box 102. Once the sticks of ice 108 have been introduced into the cooling box 102, the supply ports 106 are each closed by a stopper so as to thermally insulate the inner space delimited by the cooling box 102. Due to the presence of the coolant material 107 in the cooling box 102, the layers 3 and 5 of the insulation system 2 of the cable 1 are brought to temperatures lower than their glass transition temperatures. By being brought to such low temperatures, the different layers 3 and 5 of the insulation system 2 of the cable 1 are hardened and can therefore be better machined when preparing a section of the cable 1, this preparation consisting in removing at least part of the insulation system 2 on a section of said cable 1.

In reference to FIG. 4, an installation 101 according to the invention comprises a cutting device 120 for cutting the cable comprising a cutting blade 121, said cutting device 120 being used to prepare the cable 1. Schematically, this cutting blade 121 is inclined in relation to an outer surface of the insulation system 2 of the cable 1. It moves along the periphery of said insulation system 2, gradually cutting the layers 3 and 5 making up said insulation system 2 in order to obtain a section of cable 1 that is without at least part of the insulation system 2. As this cutting device 120 is already known, it will not be described in greater detail in the present description. When the layers 3 and 5 of the insulation system have been cooled in advance by the cooling device 101, they have hardened and can therefore be cut easily and cleanly, having a clean, perfectly defined cut edge 15 and giving the insulator 2 a smooth surface appearance after cutting.

A method for preparing an electric cable by using an installation according to the invention comprises the following steps:
a step of fixing the cooling box 102 around the section of electric cable 1 to be cooled,
a step of filling the cooling box 102 through the supply ports 106 with the coolant material 107 in the form of pieces of ice 108,
a step of closing said supply ports 106,
a step of cooling said section of the electric cable 1 by means of the cylindrical cooling box 102,
a step of cutting the outer layer 5 of semiconductor and the layer of insulation 3 of the cable 1 by means of the cutting blade 121, after said outer layer 5 of semiconductor and said layer of insulation 3 have been brought to a temperature lower than their glass transition temperature by virtue of the cooling device 101.

According to a preferred alternative embodiment of an installation 101 according to the invention, the cooling device 101, which is mainly represented by the cooling box 102, and the cutting device 120 are fixed to the inside of a common unit which can move in translation along the cable 1 to be prepared. In this way, the functions of cooling and cutting the cable 1 become inseparable, the cutting step only being able to take place when the section of cable 1 to be processed has already been cooled. Fixing the cooling device 101 and the cutting device 120 to the same common unit allows the functions of cooling and cutting the cable to be combined in the same place, which has the following consequences:
there is less risk of the components required to perform these two functions being separated and therefore of said components being lost,
the risk of forgetting to cool the cable 1 before cutting it is eliminated.

1. An installation for preparing a cable comprising:
a conductor surrounded by an insulation system comprising at least one insulating layer and at least one semiconducting layer, wherein said installation has a cooling device for cooling a section of said cable in the form of a cylindrical cooling box delimited by a cylindrical side wall and by two circular end faces, each provided with a circular opening, and in that the cylindrical side wall has at least one supply port through which a coolant material is introduced into the box, the electric cable passing through the box via the circular openings in the two end faces and being in contact with the coolant material placed in the cylindrical box.

2. The installation according to claim 1, wherein the cylindrical box is made from a thermally insulating material.

3. The installation according to claim 1, wherein the cylindrical box has at least two supply ports through which the coolant material is introduced, and in that said at least two supply ports are positioned along a top region of the cylindrical box, being aligned along a longitudinal axis of this box.

4. The installation according to claim 1, wherein the two end faces are flat and parallel to each other.

5. The installation according to claim 4, wherein the circular openings in the two end faces each occupy a central position on the corresponding end face.

6. The installation according to claim 1, wherein the coolant material consists of a plurality of pieces of dry ice, in particular pieces at a temperature in the region of −60° C. to −78° C. at the time they are introduced into the box.

7. The installation according to claim 6, wherein the pieces of ice all have identical geometry and dimensions.

8. The installation according to claim 1, wherein the insulation system of the cable includes a layer of insulation surrounded by an inner layer of semiconductor and by an outer layer of semiconductor.

9. The installation according to claim 8, wherein said installation comprises a cutting device for cutting the outer layer of semiconductor and the layer of insulation in order to prepare a section of the electric cable, and in that the cutting device comprises a cutting blade and is used after said outer layer of semiconductor and said layer of insulation have been brought to a temperature lower than their glass transition temperature by virtue of the coolant, the glass transition temperature being, in particular, between −10° C. and −50° C.

10. The installation according to claim 9, wherein said installation comprises a common unit inside which the cooling device and the cutting device are fixed, said common unit being mounted in such a way as to be able to move along the electric cable along its axis.

11. A method for preparing an electric cable by using the installation according to claim 9, wherein said method comprises the following steps:
a step of fixing the cooling box around at least part of the section of electric cable to be prepared,
a step of filling the cooling box through the supply ports with the coolant material,
a step of cooling said part of said section of the electric cable by means of the cylindrical cooling box, so as to cool the outer layer of semiconductor and said layer of insulation below their respective glass transition temperatures,
a step of cutting the outer layer of semiconductor and part of the layer of insulation of said part of said section of cable by means of the cutting blade, after said outer layer of semiconductor and said layer of insulation have been brought to a temperature lower than their respective glass transition temperatures by virtue of the cooling device.

12. The method according to claim 11, wherein said method comprises a step of moving the common unit along the electric cable in order to gradually prepare successive parts of said section of said electric cable.
